(19) United States
(12) Patent Application Publication
(10) Pub. No.: US 2009/0271265 A1
(43) Pub. Date: Oct. 29, 2009

(54) ELECTRONIC RECEIPT SYSTEM AND METHOD

(75) Inventors: Isaac Lay, Brea, CA (US); Joseph Silla, La Mirada, CA (US); Dusty Schlabach, Fullerton, CA (US)

Correspondence Address: KLARQUIST SPARKMAN, LLP, 121 SW SALMON STREET, SUITE 1600, PORTLAND, OR, 97204, US

(73) Assignee: Cyndigo, Corp.

(21) Appl. No.: 12/431,545

(22) Filed: Apr. 28, 2009

Related U.S. Application Data
(63) Continuation-in-part of application No. 12/150,355, filed on Apr. 28, 2008.

(51) Int. Cl. G06Q 30/00; G06Q 20/00

(52) U.S. Cl. 705/14.38; 705/17

(57) ABSTRACT

A system and method are provided for generating and storing electronic receipts from any type of public facing business having a live point-of-purchase and utilizing electronic payment systems, namely, a point-of-sale (POS) system having a credit card terminal or electronic cash register (ECR). A user can associate with his or her account one or more identifiers such as a credit or debit card or phone number, and the system and method can be used to facilitate a product return, accept coupons online and redeem them in-store, generate and transmit a gift receipt, and participate in retailer loyalty programs. The system and method further include account interfaces for registered merchants and users to view and manage their account information.

### CROSS REFERENCE TO RELATED APPLICATION

This application is a continuation-in-part of and claims priority to U.S. patent application Ser. No. 12/150,355, filed Apr. 28, 2008. The entire disclosure of U.S. patent application Ser. No. 12/150,355 is hereby incorporated herein by reference.

### FIELD

The present disclosure relates generally to the automatic capture, generation and transmission of an electronic receipt from a point-of-purchase. More specifically, the disclosure relates to a web based service wherein users/subscribers receive electronic receipts generated at a point-of-purchase and stored remotely for future viewing. Further, users/subscribers are identified at the point-of-purchase through a pre-registered credit/debit card or phone number for electronic receipt delivery to user/subscribers account.

### BACKGROUND

The advent of electronic or on-line shopping has led to the issuance of electronic receipts in a computer readable format. These receipts are usually provided upon completion of an on-line transaction and may be viewed and printed by the user directly from his/her computer terminal and a peripheral printer. Alternatively, an electronic receipt may be sent to the user electronically, via e-mail, for him/her to view and print out from a different computer at a later point in time.

Unfortunately, in point-of-purchase situations paper receipts are still used. More specifically, all types of merchants, banks, retailers, and service providers issue paper receipts for the various types of financial transactions, services and/or purchases which they might provide at specific point-of-purchase locations. For example, a restaurant will issue a paper receipt for a user regardless of whether the user pays with cash and/or credit. Similarly, department stores, food stores and various retail outlets will also issue a paper receipt at the time of purchase, regardless of the form or method of payment.

Use of paper receipts is outdated and represents a myriad of pitfalls and problems. First and foremost, the environment costs and concerns involved in the use of paper receipts are altogether immeasurable. Second, paper receipts are often lost, misplaced, or accidentally disfigured or destroyed. Third, paper receipts, even when stored in a safe and secure environment, tend to age and fade over time, making them entirely useless.

Accordingly, it is desirable to have a secure working paperless receipt system which can provide a secure electronic receipt for any transaction executed at any remote point-of-purchase location from any retail business anywhere in the world. Additionally, it is desirable to have a single, centrally located web based service for the delivery of all electronic receipts from every physical retail establishment in order to simplify the process for consumer's accessing their electronic receipt data. It is further desirable for these receipts to be electronically delivered, stored and easily retrieved by a user, from any remote computer location via the Internet.

### SUMMARY

The present disclosure is directed to a system and method for auto capturing and auto generating an electronic receipt from virtually any type of public facing business having a live point-of-purchase, provided that business uses and accepts electronic payment systems, namely, point-of-sale (POS) systems such as a credit card terminal and/or electronic cash register (ECR) which may further include a cash drawer, barcode scanner, receipt printer, customer facing payment terminal, touch screen, and other similar devices known in the art.

In certain embodiments, the system can include a software add-on which is integrated into the POS electronic payment system and which can be used to enroll a new user and/or authenticate/identify a user through a previously registered credit/debit card number, biometric sample, phone number or email address. The software add-on can deactivate receipt printing functionality at the POP, transmit electronic receipt information to a membership or subscriber based Internet website where it is stored in the user's account, and accept incoming product return data from a remote server/database to facilitate a product return.

The system can also include a membership or provider based Internet website for merchants to view and manage information related to electronic receipts generated from purchases of previous customers. A consumer/user can view and manage their individual electronic receipts at any time from a local Internet-ready computer terminal. This website can also preferably allow subscriber merchants to distribute coupons and advertisements to these consumers.

The system can further include an Internet website that allows business customers to create and manage expense reports and export expenditures into accounting software.

In a preferred embodiment, the system facilitates communications between a POP and a remote server/database location via a custom software add-on which is integrated into the POS electronic payment system resident at the POP. As a result of this integration, and as a function of the custom software integrated into the POS electronic payment system, a merchant is able to communicate with the server/database to identify and authenticate a consumer/subscriber via their credit/debit card, phone number or email address entered at the POP by consumer/cashier and generate an electronic receipt which is stored within the server/database location and which can be viewed by a consumer/subscriber at a later, more convenient time. The system can also transfer a copy of the receipt directly to the consumer/subscriber via e-mail or text message.

In another embodiment, a system for facilitating in-person purchases and returns of products at a plurality of points-of-purchase is provided. The system comprises a registration interface at a location remote from the points-of-purchase, the registration interface being configured to remotely receive identification information to register a user in the system and associate the registered user with a user account. The system also comprises a server at a location remote from the points-of-purchase and configured to communicate with a point-of-sale electronic payment systems resident at each point-of-purchase. The server is configured to receive and store a plurality of electronic receipts from the point-of-sale electronic payment systems, each electronic receipt being representative of one or more purchases made by a registered user at a point-of-purchase and including identification information provided by the registered user at the time of purchase. The server is also configured to associate each electronic receipt with a single user account based on the identification information included with each electronic receipt. When a product return is initiated by a registered user at a point-of-purchase, the server is configured to receive the identification information of the registered user initiating the product return from the point-of-sale electronic payment system, identify the user account associated with the identification information, retrieve one or more electronic receipts associated with the user account, and transmit the retrieved electronic receipts to the point-of-sale electronic payment system to facilitate the product return.

In specific implementations, the electronic receipts comprise one or more unique retailer-specific transaction numbers that are used by a retailer at the point-of-purchase to locate or identify purchase information associated with the one or more purchases made by the registered user at the point-of-purchase.

In other specific implementations, the system further comprises an account interface at a location remote from the points-of-purchase, the account interface being configured to provide a registered user with access to their user account to retrieve and view the electronic receipts associated with the user account of the registered user. The account interface can be configured to allow the registered user to identify and save electronic coupons in the user account of the registered user, the electronic coupons being automatically redeemable at a point-of-purchase upon the in-person purchase of a product covered by the coupon at the point-of-purchase, and the user being identified at the point-of-purchase using the identification information.

In other specific implementations, the system further comprises a second registration interface. The second registration interface can be configured to remotely receive merchant information to register a merchant having one or more point-of-sale electronic payment systems in the system and associate the registered merchant with a merchant account. In other specific implementations, each electronic receipt can include a unique account number, a merchant account number, and a receipt number. The unique account number can be associated with a single user account, the merchant account number can be associated with a single point-of-purchase, and the receipt number can be associated with a purchase made by a registered user. In other specific implementations, the identification information can comprise a number associated with a credit card or other payment card of the registered user. The identification information can also comprise a telephone number of the registered user.

In another embodiment, an enrollment system for pre-registering merchants and users to facilitate purchases and returns of products at a plurality of points-of-purchase is provided. The system comprises one or more enrollment interfaces located remotely from the points-of-purchase and a server located remotely from the points-of-purchase and accessible to the registered merchants and registered users through one or more communication networks. The enrollment interfaces can be configured to remotely receive registration information from a plurality of merchants and a plurality of users to register the merchants and users in the system. The enrollment interfaces can associate one or more unique merchant account numbers with each registered merchant and one or more unique user account numbers with each registered user. The server is configured to receive and store a plurality of electronic receipts, with each electronic receipt being representative of an in-person sale of one or more products by a registered merchant to a registered user at a point-of-purchase operated by the registered merchant. Each electronic receipt can include the unique user account number, the unique merchant account number, and a receipt number associated with the purchase made by the registered user at the point-of-purchase. When a product return is initiated by a registered user at a point-of-purchase of a registered merchant, the server is configured to receive the unique user account number of the registered user initiating the product return and provide the registered merchant with an electronic copy of at least one electronic receipt that includes both the unique user account number of the registered user and the unique merchant account number of the registered merchant.

In specific implementations, the remote server can be accessed by a registered user via the Internet, in order to retrieve and view the electronic receipts stored therein. In other specific implementations, the registered users may access the remote server and print a copy of one or more electronic receipts stored therein and associated with their unique user account number to facilitate the return of one or more products associated with the printed electronic receipts. In other specific implementations, the server can restrict the number of copies that can be printed of any single electronic receipt retrieved from the remote server by the registered user.

In other specific implementation, registered user can receive electronic coupons and the remote server is configured to save electronic coupons and associate them with a registered user. The electronic coupons can be automatically redeemable at the point-of-purchase of a registered merchant when the registered user provides the registered merchant with a unique user account number. In other specific implementations, the remote server can be accessed by a registered merchant in order to retrieve the electronic receipts associated with the registered merchant and to provide electronic coupons to one or more registered users.

In another embodiment, a method for generating and storing electronic receipt information to facilitate in-person purchases and returns of products at a plurality of points-of-purchase is provided. The method comprises registering a plurality of users with a plurality of respective user accounts; associating each user account a unique user identifier; registering a plurality of merchants with a plurality of respective merchant accounts; associating each merchant account with a unique merchant identifier; receiving a plurality of electronic receipts from registered merchants at a remote server, with each electronic receipt being representative of one or more in-person purchases made by a registered user at a point-of-purchase associated with a registered merchant; storing the plurality of electronic receipts at the remote server; receiving a request from a registered merchant for an electronic receipt stored at the remote server, the request including at least the unique user identifier and the unique merchant identifier; identifying one or more electronic receipts stored at the remote server and associated with both the unique user identifier and the unique merchant identifier; and transmitting the identified electronic receipt to the registered merchant so that the registered merchant can receive the electronic receipt and process a product return.

In specific implementations, the electronic receipt transmitted to the registered merchant comprises one or more unique transaction numbers that correspond to receipt identification information located or accessible at the point-of-purchase. In other specific implementations, the act of associating each user account with a unique user identifier comprises accepting credit or debit card information entered by the registered user, truncating said credit or debit card information, and storing said truncated credit or debit card information in a database.

In other specific implementations, the method comprises receiving product return information from the registered merchant indicating whether a product has been returned to the registered merchant; updating the electronic receipt stored at the remote server to reflect the product return; and storing the updated electronic receipt at the remote server.

In other specific implementations, the remote server may be accessed by the registered user via the Internet, in order to retrieve the updated electronic receipt stored therein. A registered user can also access the remote server and the updated electronic receipt stored therein in order to generate a paper receipt which may be downloaded to and printed on a local printer.

This Summary is intended to briefly identify some aspects of the subject matter that is further described below in the Detailed Description. This Summary is not intended to identify key or essential features of the claimed subject matter, nor is it intended to be used to limit the scope of the claimed subject matter. The foregoing and other features and advantages of the embodiments disclosed herein will become more apparent from the following detailed description, which proceeds with reference to the accompanying figures.

### BRIEF DESCRIPTION OF DRAWINGS

FIG. 1 illustrates an embodiment of a system for generating and/or storing electronic receipt information;

FIG. 2 illustrates a flow chart depicting various steps that can be taken in an on-line or Internet enrollment of a consumer/purchaser type client into a system for generating and/or storing electronic receipt information;

FIG. 3 illustrates an embodiment of an enrollment or registration webpage that provides an array of fields for entering various personal and/or demographic information;

FIG. 4 illustrates a flow chart that shows steps that can be executed in an embodiment that provides for enrolling a consumer/purchaser directly on site from a POP location;

FIG. 5 illustrates a flow chart that shows steps that can be taken in an embodiment that provides for enrollment of a POP merchant/seller location into a system for generating and/or storing electronic receipt information;

FIG. 6 illustrates a flow chart that shows steps that can be taken for generating and storing an electronic receipt information in a preferred embodiment;

FIG. 7 illustrates an embodiment in which a listing of receipt headers for various purchases/transactions are visible to a subscribing consumer/purchaser when he/she accesses their account;

FIG. 8 illustrates an electronic receipt that can be generated in a preferred embodiment; and

FIG. 9 illustrates a flow chart showing steps that can be taken to initiate and process an in-person return of a product.

### DETAILED DESCRIPTION

The following detailed description includes references to the accompanying drawings, which form a part of the detailed description. The drawings show, by way of illustration, example embodiments in which the subject matter may be practiced. These embodiments, which are also referred to herein as “examples,” are described in enough detail to enable those skilled in the art to practice the subject matter. The embodiments may be combined, other embodiments may be used, or structural, logical, and electrical changes may be made without departing from the scope of the present subject matter. The following detailed description is, therefore, not to be taken in a limiting sense, and the scope of the present subject matter is defined by the appended claims and their equivalents.

As used herein, “point of sale system” or “point of sale electronic payment system” refers generally to a point of sale terminal and/or the hardware and software used for facilitating a payment by a purchaser or a sale by a seller, including, for example, electronic cash registers, credit card terminals, computer sales terminals, and the like. As used herein, “point of purchase” refers to the physical location of an in-person sale of goods or services at any type of retail or service establishment, including, for example, a store, supermarket, restaurant, hotel, and the like.

As used herein, “electronic receipt” refers generally to data that can be electronically transmitted and/or received. An electronic receipt comprises information that is representative of a purchase made by a consumer and/or which can be used to identify or locate information that is representative of a purchase made by a consumer. For example, an electronic receipt can comprise information such as is typically generated and emailed to a consumer when the consumer makes an online purchase. Alternatively, an electronic receipt can comprise information, such as a unique identifier, that does not contain the actual purchase information, but which contains information that can be used to identify and/or locate receipt information that is stored or located elsewhere.

The present disclosure is directed to a system and method for auto generating an electronic receipt from virtually any type of public facing business having a live point-of-purchase, provided that such business uses and accepts electronic payment systems, namely, point-of-sale (POS) electronic payment systems such as a credit card terminal and/or electronic cash register (ECR) which may further include a cash drawer, barcode scanner, receipt printer, customer facing payment terminal, touch screen, other similar point-of-sale peripherals known in the art.

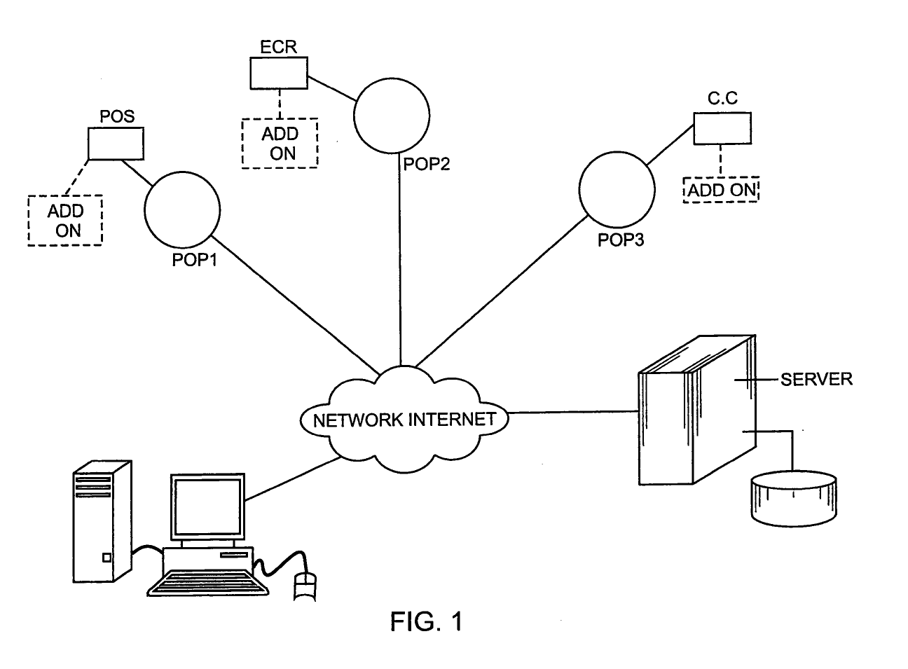

FIG. 1 illustrates a preferred embodiment for a system for generating and/or storing electronic receipts. As shown in FIG. 1, the system can include a number of point-of-purchase locations for a plurality of merchant businesses and stores and/or service providers. Each point-of-purchase location can utilize some type of POS electronic payment system, such as a credit card terminal (CC) and/or an electronic cash register (ECR), which may also further include a cash drawer, barcode scanner, receipt printer, customer facing payment terminal, touch screen, etc.

The POS electronic payment system at each POP merchant location is preferably equipped with a custom software add-on which is integrated into the POS electronic payment system at the merchant's POP location. This software performs/enables many of the functions described in greater detail further hereinafter. The software can comprise, for example, computer-executable instructions stored on a computer-readable storage medium (e.g., a hard drive or memory) associated with the POS electronic payment system.

The system can further include a remote membership or subscriber based Internet server/database location which is in communication through the Web Service with each individual merchant POP location via the POS electronic payment system and the custom software add-on resident at that location. As will be described in further detail hereinafter, the remote membership or subscriber based Internet server/database location provides a network accessible website (e.g., via the Internet) where consumers may view and manage their individual electronic receipts from any remote location using a computer terminal/keyboard having Internet access.

As illustrated in FIG. 1, the system can facilitate communications between each individual POP and a remote Internet server/database location via a custom software add-on which is preferably integrated into the POS at the merchant location. The custom software add-on is used to acquire receipt data from customer transactions in order to generate an electronic receipt which is transmitted and stored at the remote Internet server/database location. These receipts may be viewed by a consumer/subscriber at a later, more convenient time. In one embodiment, the remote Internet server/database location can be configured to transfer a copy of the receipt directly to the consumer/subscriber via e-mail or text message.

The server of FIG. 1 can be a computer system that is designated for running the software required to perform the processes discussed in more detail below. The server may consist of a single server computer or it may comprise multiple server computers that are directly or indirectly linked together. As shown in FIG. 1, the information and data can be transferred to and from each POP and server via a network. The network can comprise any type of network capable of transferring electronic information and may include, for example, the Internet, local area networks (LANs), wide area networks (WANs), or any combination thereof.

### Enrollment/Subscription

As indicated earlier herein, in a preferred embodiment, the system can be a subscriber/user based system that is useful to two different types of clients, merchants and consumers/purchasers. Clients may subscribe via a webpage preferably available over the Internet, although other modes of subscription are possible—including, for example, over the telephone, by regular or electronic mail, and live enrollment of a consumer/purchaser type client directly from a POP location equipped with a POS electronic payment system and the custom software add-on. Each client type must be a subscribing member and the enrollment process for each can be different. Examples of various enrollment/subscription methods are now discussed in further detail.

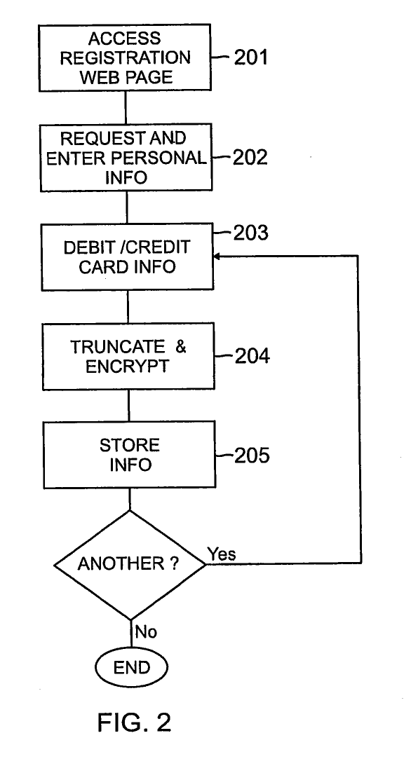

FIG. 2 illustrates a flow chart for the steps taken in an on-line or Internet enrollment of a consumer/purchaser type client. In an embodiment of a webpage/on-line enrollment of a consumers/purchaser type client, the consumer/purchaser can access the remoter server/database location via the Internet and pull up a registration web page using a computer terminal/keyboard which has Internet access 201. Information from the server is preferably transmitted to the computer terminal via the network to guide the consumer/purchaser through the enrollment process. Preferably, the consumer/purchaser has a computer terminal with a display capable of showing the necessary information transmitted from the server. The server can comprise one or more computer systems that have a main or secondary memory or other computer-readable storage medium (e.g., a hard drive) that stores computer programs (e.g., computer-executable instructions) and one or more processors capable of executing the computer programs in order to perform the server-initiated and/or -controlled steps described below.

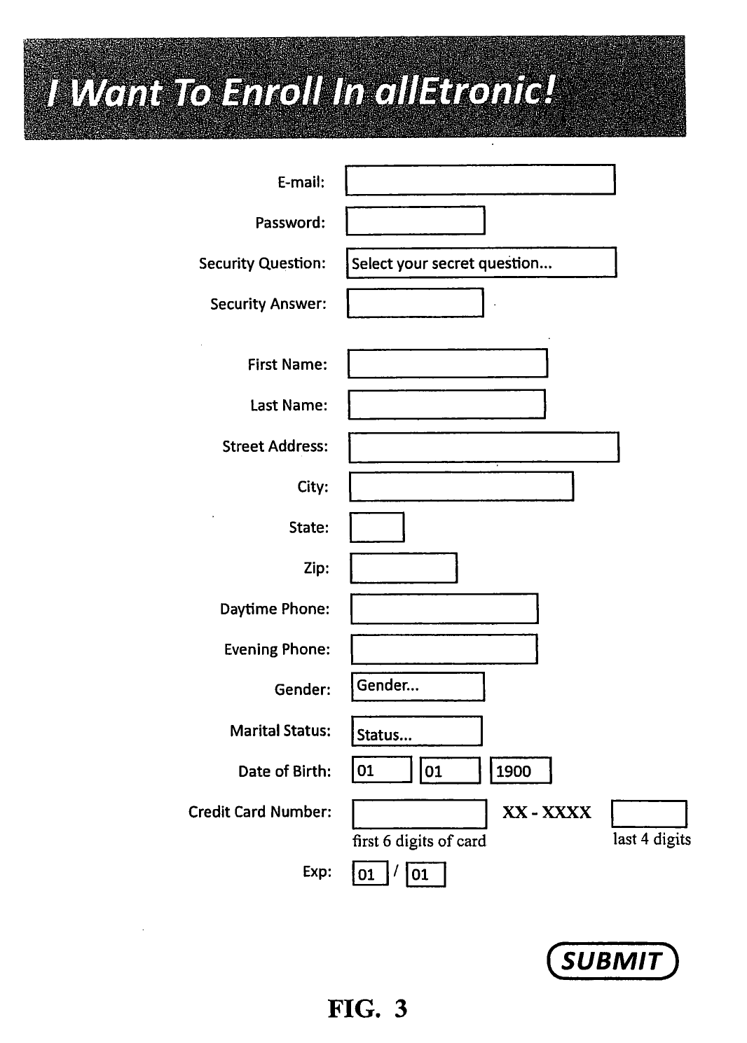

The registration web page is preferably configured to request an array of personal, demographic information from the new enrollee (the consumer/purchaser client) such as his or her name, address, and telephone number 202. FIG. 3 illustrates an embodiment of an enrollment or registration interface (here, a graphical user interface) that provides an array of fields of which a new user can enter various personal and/or demographic information, such as his or her name, address, and telephone number. The interface can be remotely located from the point-of-purchase and can comprise, for example, an Internet webpage that is displayed to the user. Thus, the individual consumer/purchaser client can enter this information from his/her local computer terminal/keyboard. After entry of this or similar information, the user is registered in the system and a user account can be associated with the registered user.

Referring again to FIG. 2, the system is also preferably configured to request that the consumer/purchaser enter at least one phone number and one credit/debit card number which he or she wishes to have linked to their account 203. The user can enter the credit or debit card number, the three or four digit security code appearing on the card, the expiration date, and a first and last name, or last name only.

The system preferably uses a truncation and encryption algorithm to truncate and encrypt the card number and store the result (along with the other identifying information previously entered) in a database under the subscriber's/purchaser's account 204. It should be noted that, in one embodiment, at no time is the actual credit card number ever stored, even though certain security measures may be taken to facilitate the secure storage of a full credit card number. Thus, in some embodiments, only the end result of the truncation/encryption operation is stored at the remote server/database location 205.

Upon enrollment, enrollee's can link as many credit or debit cards to their account as desired. A business owner, for example, can link both personal debit/credit card(s) and business debit/credit card(s) to the same account, thus making the tracking of both personal and business card based transactions (and related receipts) much easier.

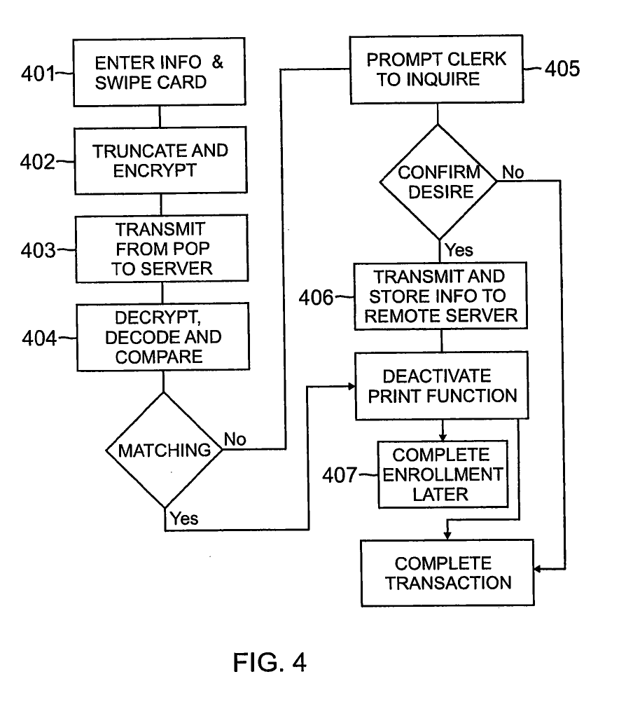

As explained earlier, the system also provides for live enrollment of a consumer/purchaser type client directly from a POP location equipped with a POS electronic payment system and the custom software add-on. FIG. 4 illustrates a flow chart which shows the steps executed when enrolling a consumer/purchaser directly on site from a POP location. In this situation, a new consumer account can be created by a cashier directly at the POS system by entering the customer's phone number, email address or by swiping the customer's credit/debit card 401.

Once the credit or debit card is swiped, the card information can be truncated and encrypted by the software add-on at the POP 402 and the truncated/encrypted card info, along with the phone number and/or e-mail address, can be transmitted from the POP location to the remote server/database location, where the information can be decrypted and compared to previously stored information 403, 404.

If there is no matching entry, a signal is returned to the clerk/cashier at the POP, prompting him/her to inquire as to whether the purchaser/consumer wishes to become a member in to the system and thereafter begin receiving electronic receipts 405. If the user affirms the intent to become a member, the clerk/cashier will confirm this intent and a return/confirmation signal will be transmitted from the software add-on at the POP to the remote server/database location so the customers phone and/or e-mail and credit/debit card number may be stored 406.

If only a phone number was entered or provided to the cashier, an automated system can be used to call the customer 2-3 days after their purchase and remind them to log into the remote server/database using their own local home computer terminal/keyboard to that they may finalize the enrollment process by visiting the website 407. Similarly, if only an email was entered or provided to the cashier: an automated email may be sent to the customer immediately after their purchase reminding them to log into the remote server/database using their own local home computer terminal/keyboard to that they may finalize the enrollment process by visiting the website 407.

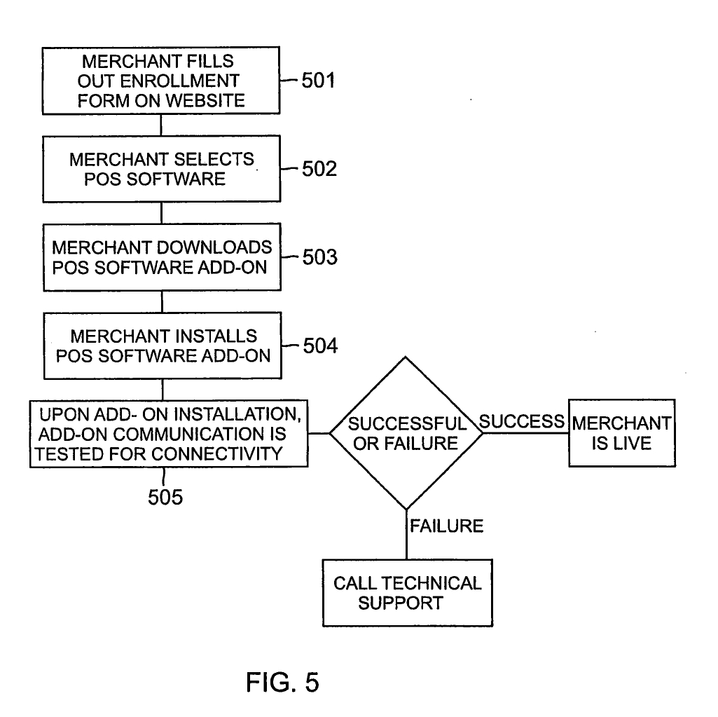

As explained earlier herein, the systems described herein can also provide member merchants with their own accounts where information about various purchasers may be stored. This information allows merchants to target specific consumers with coupons or advertising based upon their prior purchasing behavior/information. FIG. 5 illustrates a flow chart for steps that can be performed to enroll a POP merchant/seller location in a system as described herein. As shown in FIG. 5, for example, a merchant can access the remote server/database location via the Internet and pull up a merchant subscriber registration web page that can be completed by the merchant 501. Much like the consumer user webpage, this registration page asks the merchant to provide certain personal and/or demographic information. As will be discussed later herein, this information can include details about the products/services offered by the merchant in order to categorize receipts generated from the merchant's POP location.

The merchant can select a customized software-add on for their POS system 502. Preferably, the software add-on may come in several options depending upon the particular POS system used by the merchant at their POP location. This software add-on can be downloaded to the merchants POS system from the remote server/database location 503 and installed within the merchant's POS system for operation 504. Alternatively, the software can be stored on a disk or other portable storage medium and mailed or otherwise delivered to the location of the POS system and the merchant can directly load or install the add-on software to the POS system upon receipt of the software.

Once the software add-on has been successfully selected and installed, the software will run a trial connection and attempt to communicate with the remote server/database location in order to ensure that it is operating properly 505. If the trial connection is successful and the software add-on is running properly then the merchant is connected within the network and fully operational. If the trial connection is unsuccessful, an error message will be returned and the merchant will be instructed to call technical/customer support in order to debug/address the issue and ensure proper connection and operation of the software add-on.

### Generating Electronic Receipts

Upon enrolling, the system can provide consumer/purchaser members with a whole host of services including the generation, transmittal, storage and retrieval of electronic receipts, as well as the ability to initiate a return from virtually any type of public facing business having a live point-of-purchase, provided that business uses and accepts electronic payment systems, including a point-of-sale (POS) system having a credit card terminal and/or electronic cash register (ECR) which may optionally further include a cash drawer, barcode scanner, receipt printer, customer facing payment terminal, touch screen, and/or other peripheral devices.

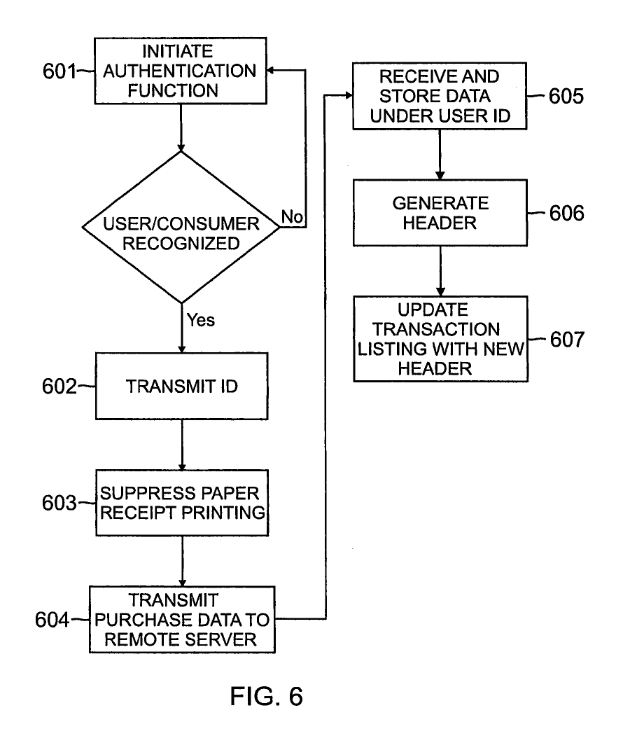

FIG. 6 is a flow-chart that illustrates operation of the system in generating and storing electronic receipts/receipt information, in accordance with a preferred embodiment. As shown in FIG. 6, when a consumer who is a subscriber to the system engages in a transaction at a participating business, the add-on software will initiate an authentication function to ensure that the user is a subscriber/member to the system 601. More specifically, when a consumer initiates a transaction at a POP, a clerk or attendant, or even the customer themselves will either manually enter some identifying information such as a user's telephone number and/or e-mail address into the customer facing payment terminal or device; or, the clerk/attendant/customer will swipe the consumer's credit or debit card. The custom software add-on integrated into the POS electronic payment system can then utilize this information to authenticate the consumer as described below.

If a phone number or email address is entered by the clerk/attendant/consumer at the POP using a keyboard, customer facing payment terminal, or any other device known in the art, this information can be transmitted to the remoter server/database location where a conventional search (utilizing techniques well known in the art) can be conducted to compare the information input by the clerk/attendant/consumer with information stored at the remote server/database location in order to see if the consumer is indeed a subscriber member with an active account.

If a credit card is swiped at the POS location, or waived in front of a RFID receiver, as in the case of contactless enabled credit cards, the card number can be truncated and encrypted and the result can be transmitted from the POS to the remoter server/database location in order to identify the consumer and link the electronic receipt transaction to their account. At the remote server/database location, the encrypted/truncated card number can be decrypted. The truncated card number can be then compared with the truncated results previously stored in order to match the user to his/her account.

Other authentication methods are possible and are within the spirit and scope of the invention. Such methods may include a magnetic strip, barcode or RFID chip enabled membership card which the user might swipe, scan or wave using a credit/debit card reader at the POP while engaging in the transaction, a secure pin number which the user might enter while engaging in a transaction at a POP, or a biometric identifier such a fingerprint which might be scanned at the POP and then transferred to the remote server/database location for verification.

Once the user has been authenticated, the remoter server/database can transmit a Consumer ID to the POS electronic payment system at the POP 602, informing the software add-on within the POS electronic payment system of a successful authentication/validation. The custom software add-on can then initiate a set of procedures and/or instructions for generating and transmitting an electronic receipt.

First, the POS software add-on can instruct the POS electronic payment system to suppress printing of a paper receipt 603, thus any printer coupled to the POS electronic payment system can be prevented from printing a receipt. The software add-on at the POP will then package and transmit specific purchase information related to the purchase to the remoter server/database location 604 (this information can include, for example, the Merchant ID, the Consumer ID, Date, Time, Item Purchased & Price (for each individual item), the Subtotal, Shipping Charges (if applicable), Tax, Discounts (if applicable), Grand Total, Payment Method, Payment Amount, and Change Returned). This information can be received at the remote server/database location and stored in the consumer/member's individual account for future use/reference 605.

The system can include an account interface through which a registered user/individual can access their user account. In addition, upon enrolling in the system, consumers can be given a plurality of standard categories/folders in which the receipt data for each transaction can be stored. In a preferred embodiment, there are at least five (5) categories/folders to select from. This feature allows a consumer to more effectively track their spending as it relates to their unique or typical household purchases. These standard categories, which can easily be customized and changed, can include, for example: General, Utilities, Household, Food, & Entertainment. When a specific merchant or POP location becomes a provider under the system, the system can categorize that business and/or its goods and services into one or multiple categories or business type identifiers which are directly related to these standard categories. Thus when receipts are generated and transmitted from member merchants' POP locations, they can be matched up to and stored within a consumer/purchaser's individual account under one of these categories/folders.

Alternatively, consumers may create their own specific folders within their account. Accordingly, if a consumer wants to create a custom folder category within their account and link all their purchases from a particular business to said folder/category, they may do so. This will allow each consumer to more effectively track their spending.

### Consumer Portal

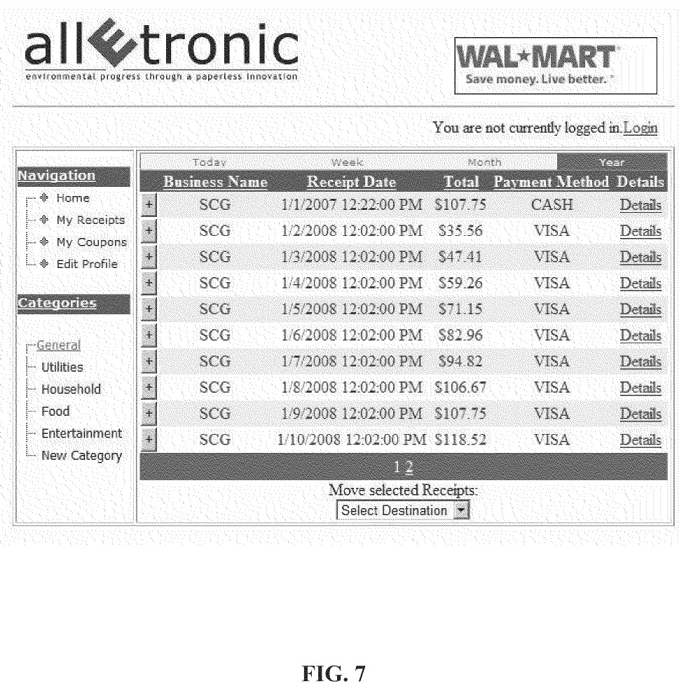

Upon receiving the information, the remote server/database can generate a single header line which can contain a select subset of this information 606. This can preferably include the Merchant ID, the Date, the Time, the Grand Total and the Payment Method. This header can then be displayed in a listing which is visible to the individual consumer/purchaser over the Internet whenever he/she logs into the account via the Internet from any remote computer terminal/keyboard location 607. In a preferred embodiment, the most recent account transactions are at the top of the listing, and the listing is configured to display the ten (10) most recent transactions. FIG. 7 illustrates a preferred embodiment for such a listing.

Accordingly, upon successful login subscribing consumers will be shown a listing of their ten most recent transactions for any of the debit or credit cards linked to the account. Users may select any of the items on the list in order to view more specific receipt details for that particular purchase/transaction. More specifically, using their remote computer terminal/keyboard, a user can scroll through the listing of their recent transactions in order to pull up a detailed receipt for that transaction. Alternatively, the system also includes various search functionalities. For example, in a preferred embodiment, users to the system have the option of searching a range of dates in order to retrieve receipts within that date range and/or searching for any and all receipts generated from transactions with a particular business or merchant (e.g., all receipts for purchases from Best Buy).

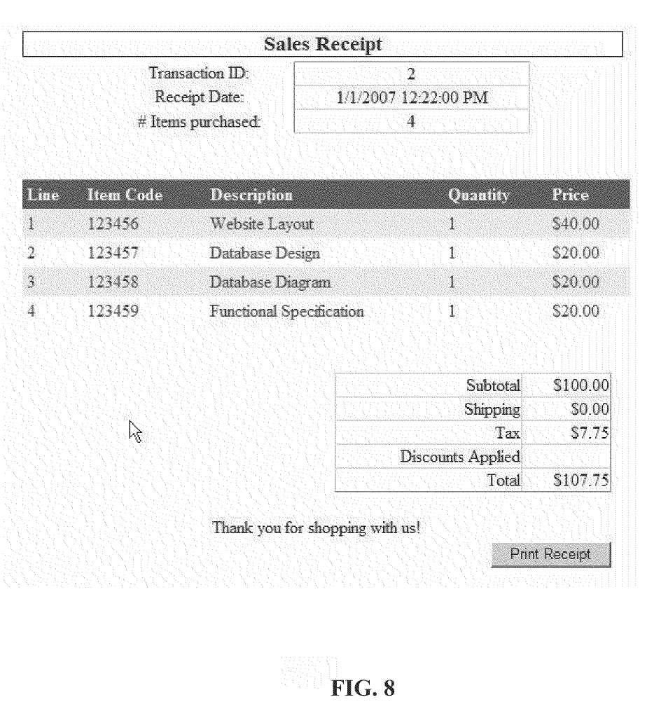

FIG. 8 illustrates the preferred embodiment for an individual receipt. Referring to FIG. 8 it shows specific purchase details for the first transaction shown in the listing of FIG. 7. These specific purchase details preferably include the individual items purchased (code and name/description), the quantity of each item purchased, the individual price, the shipping charges (if any), tax, discounts or coupons (if any) and the grand total for that particular transaction. The user is provided with a further option of printing a paper copy of the electronic receipt. If the user selects this option, the electronic receipt is downloaded to and printed by a local printer coupled to the user's computer terminal/keyboard.

In certain embodiments, the system can be configured to provide other user operations. For example, consumers will have the ability to (1) export receipt data into any accounting program of their choice, (2) add receipts from merchants that aren't members of our environmental network, (3) initiate a product return or exchange with any merchant or POP member in the network, and/or (4) e-mail a gift receipts to a gift recipient void of associated dollar amount, or send it to a recipients account (provided that the recipient is a member to the system) using the recipient's name and phone number. These additional features are described in further detail hereinafter.

(1) Export Receipts

Using this feature of the system, users are able to select receipt information for download and import into their financial accounting software. More specifically, users can search through their receipts using several parameters (e.g., a user can search for receipts given a range of dates, keywords, business name, business type, and/or even under pre-created receipt categories) and once the consumer has generated their report of receipts based on their search criteria, the software resident on the remote server/database can provide the user/consumer with an option of exporting any one or all of said receipts and downloading them to his/her local computer. After selecting this option to export their receipts, the consumer is given the names of several popular accounting programs (and associated file format extensions) to choose from. Based on the program selected, the receipt(s) can be prepared/translated into the selected file format and then downloaded to the user/consumers local computer terminal (where they are then saved in an accounting program-friendly file format).

(2) Add Receipts

This feature allows a user to manually enter specific information in order to generate an electronic receipt for a purchase which might have been made at a merchant/retailer location not having a POS equipped with the software add-on described herein. More specifically, if a consumer obtains a paper receipt from a business/merchant that is not a member of a system and/or network described herein, the consumer is able to login to their account and manually input receipt data from the paper receipt they were given. Alternatively, if the consumer has a scanner, they can easily scan the receipt, upload the scanned receipt (for example in a .jpg or .gif format), and assign and input basic tracking parameters to the image receipt such as category, business name, business type, and amount.

(3) Product Returns

This feature allows a user to initiate a product return process by auto-transmitted return information from the remote server/database to a desired merchant/retailer regarding an item(s) to be returned. More specifically, if a consumer wishes to make a return at a particular store for a specific product, they first need to locate the receipt containing the product they wish to return. There are many ways to do this. For example, if the consumer knows when they made their purchase, they can simply select a range of dates to see receipts from businesses within that time frame. Alternatively, if the consumer knows where they made their purchase, they can locate the respective receipt by searching using the business name.

Once the appropriate receipt has been located, the customer can select the line item on said receipt which corresponds with the item they wish to return. When they select the line item they can be prompted with several options, including a ‘Return’ option. If the ‘Return’ option is selected, the remote server/database initiates an electronic communication with the store associated with the receipt from which the return item has been selected. The remote server/database can electronically contact the store that the purchase was made at and inform their POS system that this customer has initiated a product return. The customer can then return the items to the store/POP either in person or by mail/shipment. Once the product is received at the store, they can match the returned product with the return information previously transmitted to the store. This will be particularly efficient when dealing with any retail return and also mail/shipment returns because the merchant/seller can very easily match the returned product with the receipt information and process the return much more quickly. This method allows the business to confirm with 100% certainty that the product was initially purchased at the store, thereby reducing the business risk of return fraud and enhancing the businesses loss prevention.

Once the store finalizes the return at the POP, the add-on software at the merchant's POP location can then preferably communicate the details of the updated receipt back to the remote server/database where this update receipt information is then stored to the consumer's individual account. Accordingly, within the consumers account, the user/consumer will see that the receipt shows an update and that the specific product has been returned.

(4) Gift Receipt

This feature allows a user to auto create and transmit a gift receipt to any recipient having a known e-mail or mailing address. More specifically, if a consumer wishes to send a gift receipt, the user first locates the original receipt upon which the “gift” purchase is indicated from the receipts stored at the remote server/database location under their individual account. Once that receipt has been located, the consumer can select the line item or items within that receipt which represent the “gift” purchased. Once selected, the user will be prompted by the remote server/database location with several options, including ‘Send as Gift’. If ‘Send as Gift’ is selected by the consumer, the consumer/user can then be given two options for transmission of a gift receipt:

i) A gift receipt for those item(s) can be auto-generated by the software resident on the remote server/database using the selected information and this gift receipt can then be automatically transmitted from the remote server/database location to a specific email address entered by the user/consumer; or

ii) The user can attempt to locate and identify the recipient by inputting the email address of the recipient and the system can search to see if that e-mail is identified and associated with any other subscribing member/purchaser. If the system locates a match, the identity of the matching person (name and address) is presented for confirmation. If the user recognizes and confirms the name and address, a gift receipt is auto-generated by the system and this gift receipt is then transmitted to an e-mail or mailing address associated with that recipient's account.

### Merchant Portal

Merchant's typically implement rewards programs for the purpose of being able to track the spending habits of its customers. They typically attract consumers into their programs by offering product discounts for being a member. If a customer does not enroll in such a program, however, the merchant has no way of tracking that particular customer or the products they purchase. When a merchant becomes a subscribing member of the present system, they receive all types of information about the customers who patronize their business, provided, of course, that such customers are also enrolled into the system.

More specifically, after an enrolled consumer makes a purchase, the system can notify the merchant of these consumer(s) and provide them with relevant consumer data which can be transmitted from the POP to the remote server/database and stored in that merchant/provider's account for future use reference. The consumer information will include such things as items purchased and dates of purchase, as well as the customer's name, address and phone number. This information will allow merchants to track all data as it relates to a particular customer and their spending habits within their store(s). Merchants will be able to map customer data based on the frequency of their purchases.

### Additional System Advantages and Benefits

As described above in the various embodiments, after a consumer/user creates an account in the system, the consumer/user can receive and access all of their electronic receipts at a single website. Each purchase from a retailer/merchant that has also opted into the service can generate a digital/electronic receipt that is electronically sent into the user's online account directly from the checkout stand, otherwise known as the Point-of-Purchase (POP), located within the store.

As a subscriber to the service, a user can link as many credit, debit cards, other payment cards, phone numbers, or other unique personal identifiers to their online account as desired. These unique personal identifiers can be used at the Point-of-Purchase (POP) to identify the particular user of the system and to facilitate delivery of the user's electronic receipts into their online user account, as discussed above. In other words, all a user needs to do at the checkout stand is swipe a linked payment card, provide or punch-in a linked phone number, or otherwise submit the necessary identifying information to the merchant/seller in order to be identified by the system and receive their digital receipt. In addition to these linked identifiers being used to identify a system user and deliver an electronic receipt to the proper account, users can also use their linked identifiers to: (1) return a product without a paper receipt, (2) participate in a retailer's loyalty program without having to carry a card or keychain fob, (3) redeem coupons automatically at the checkout stand without having to previously clip or print a coupon, and (4) participate in points or rewards program offered by manufacturers.

(1) Product Returns at Point-of-Purchase

The systems described herein can significantly reduce the risk of fraudulent returns, as well as greatly simplify the return process at the Point-of-Purchase. As discussed above, in certain embodiments, a system subscriber can initiate and complete a return through the online system. However, the return of a product at the Point-of-Purchase can also be facilitated using the systems described herein. In the event a user receives a paperless receipt from a retailer and subsequently wants to return a product initially present on their paperless receipt, the risk of a fraudulent receipt being produced by the person returning the product is eliminated since the receipt is retrievable through the system by the retailer. Additionally, the return of products using the electronic receipt systems described herein is faster and easier for both the customer and retailer. By reducing the labor and various complications associated with product returns, the retailer can reduce labor costs and the customer can receive their refund without undergoing the difficulties that often arise with product returns.

For example, in a conventional, paper receipt sale, if a customer lost or forgot their receipt, they must present the payment card they used to pay in order to begin the return process. By swiping the customer's payment card, the cashier may be able to retrieve the receipt corresponding to that card. However, if the customer doesn't have the corresponding payment card, whether it was lost, stolen, expired, or deactivated due to fraud, more work and time is required to find the receipt, a retailer may refuse to provide the customer with a cash refund for the product. Thus, the decision to provide a refund or store credit may lie with the store's return policy, which is unique to each retailer.

Using the electronic receipt system, a consumer can obtain a refund from a retailer in several ways. The user can return the product through their online account as described above, the user can print their receipt from the their online account and return to the Point-of-Purchase to obtain a refund, or the retailer can look up the receipt using one of the unique identifies described above.

These return processes, whether paper or paperless, are possible because of (a) a unique account number that is assigned to each user when they enroll, (b) the retailer's merchant ID (MID) number, which could be store or location specific and is issued when a retailer signs up to offer the service to customers, and (c) a unique transaction or receipt number that retailer's generate every time a receipt is issued to a customer. When an electronic receipt is generated, the retailers unique MID and unique receipt number are automatically tied to the users unique account number. Once linked, the retailer can easily make the connection between the user's identifiers and the product they are trying to return and the appropriate retailer/store/location and unique transaction/receipt number. Lastly, the system can quickly identify at which retailer the user is attempting to return a product because of the MID installed on the retailers POS system or back office computer. Accordingly, when the system receives communication from the POS requesting that the system identify a consumer that has presented one or more of their unique identifiers, the system can also receive the MID that is installed on the POS. This tells the system that Customer X is trying to return a product at Retailer Y, so the system will only locate and present data on Retailer Y receipts for Customer X.

Thus, using the systems described herein, when a user wants to return a product at the Point-of-Purchase, he or she can simply walk into the store with the corresponding product and present the cashier with any one of their linked payment cards, phone numbers, or other previously linked unique identifier instead of a traditional paper receipt. Because the identifiers presented to the cashier have been linked and are unique to the user's online account, the cashier can receive and use any linked identifier to identify the user and begin processing the paperless return. Once the system has received the retailer's MID and identified the user, the system can return a unique Return ID to the retailer's POS system. The cashier can then be prompted to obtain the product SKU information, which can occur before or after the user is identified by either scanning the product or keying-in the numerical value of the barcode. The cashier also has the option of keying-in the quantity being returned. Once the system has obtained this information, the system's database can be queried to figure out which of the user's online receipts from the retailer belong to the specific product. Once the system identifies the appropriate product and receipt, the system can return at least the retailers unique Transaction or Receipt Number, but it could also include a Return Detail ID, UPC Code, Date of Purchase, and Purchase Price at time of purchase. By providing this data to the retailer, the cashier will be able to manually or automatically retrieve the appropriate receipt for this particular customer and for the product being returned from within their own POS system. The return method serves as a reference point for the retailer to identify the user and quickly locate the user's receipt within the retailer's own library of receipts. Once the paperless return process has been completed, the user's paperless receipt can be updated and reflect the product return within their online account.

If a user chooses to print their receipt for the product return (i.e., using a paper-based return method), various security measures can be used to help retailers reduce fraudulent returns. For example, the system can be set up so that the user only has the opportunity to print a “returnable” receipt once. In other words, only the first receipt that a users prints from within the user interface will have the necessary data for a retailer to process a return. After that, the user will have to use the paperless return option described above. When a user prints their receipt for the first time, it will include a unique bar code that the cashier may scan to determine the legitimacy of the receipt.

The bar code can include at least the retailers unique Transaction or Receipt Number, but it can also include a Return Detail ID, UPC Code, Date of Purchase, and the Purchase Price at time of purchase. Once scanned, the cashier can manually or automatically retrieve the appropriate receipt from within the retailer's own system for this particular user and for the product being returned. Using this return method, the barcode can serve as a reference point for the retailer to identify the user and quickly locate the user's receipt within the retailer's own library of receipts. Once the barcode-paper return process has been completed, the users paperless receipt will be updated and reflect the product return within their online account. Although users are only able to print a receipt from within their online account once, they may still own a copy machine. So, if the user makes copies for the purpose of attempting a fraudulent return, the barcode data will allow the retailer to locate their in-house receipt data which will reflect the previously returned product and serve as a warning to the cashier. The system can also provide confirmation and indicate to the cashier that the product has already been returned. If the user wants to print more of the same receipts for filing purposes, the receipt will print but without the barcode and it will have a caption stating that this receipt is not valid for doing a return or obtaining a refund.

Other features can allow the cashier to scan multiple products that are being returned even if there are multiple receipts in the users account from this particular merchant. For example, if there are multiple products being returned, and if the products being returned appear on several different electronic receipts, the cashier can continue scanning the products until finished and will only perform a single return process for that particular user.

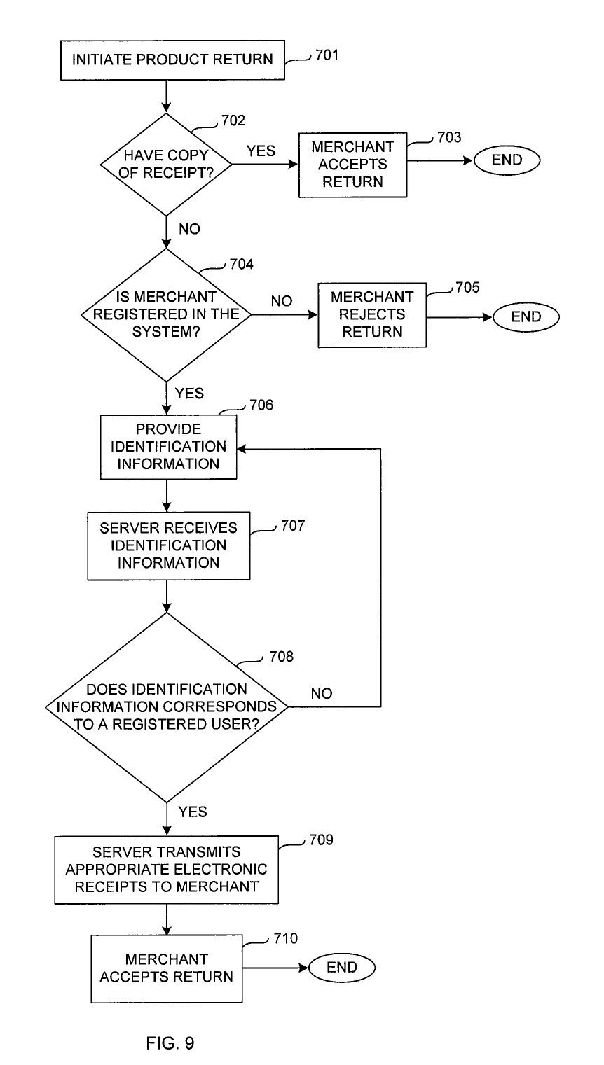

FIG. 9 is a flow chart that shows one embodiment for returning a product purchased at a particular point-of-purchase. Initially, a registered user has purchased a product from a registered merchant at a point-of-purchase. As shown in FIG. 9, a registered user can later initiate a product return 701 at the same point-of-purchase. If the registered user has a copy of the receipt 702, either an original paper copy of a printed copy retrieved through the system as described above, the merchant will accept the return 703. However, if the registered user does not have a copy of the receipt, the success of the return will depend on whether the merchant is registered in the system 704. If the merchant is not registered in the system, the merchant may reject the return 705. Alternatively, the merchant may accept the return but on a limited basis (e.g., for store credit only).

If the merchant is registered in the system, the merchant can request that the registered user provide identification information 706. The identification information can comprise one or more unique identifiers associated with the registered user and as described herein. For example, the registered user can provide a payment card (either the one that was made to make the purchase or another card that is associated with the registered user), a telephone number, etc. The registered merchant transmits the identification information to the system and the information is received by the server 707.

The server then determines whether the transmitted identification information corresponds to a registered user 708. If not, the server transmits an appropriate response to the registered merchant to indicate that the identification information does not correspond to a registered user in the system. If the identification information is found to correspond to a registered user, the server transmits the appropriate electronic receipts (or information representative of the electronic receipts) to the registered merchant 709. Upon receipt of the electronic receipts, the registered merchant processes the product return 710.

(2) Loyalty Programs Tied to User Linked Identifiers

The system can also allow a retailer to tie their loyalty program participation and customer identification to the payment cards or phone numbers their customers and system users have linked to their online accounts as identifiers. If a user has previously enrolled in the retailer's loyalty program, they would be “recognized” as a loyalty member by swiping a linked payment card or by providing or punching-in a linked phone number at the checkout. The system can not only identify the user to deliver a digital receipt, but it can also tell the retailer's POS system that the customer is a loyalty member. If a consumer has not enrolled into a retailer's loyalty program, the user may view a request to enroll in said program from within their online account or on the digital receipt itself. The system offers the user the capability to enroll into a retailer's loyalty program using a one-click enrollment feature. Retailers typically require their customers to fill out applications in order to participate in their loyalty programs. Since a participating user will have already “enrolled” in the system as described above, the system will likely have already received the information that traditionally appears on a retailer application. Thus, by providing a one-click enrollment feature, the user will not need to fill out a form, and the retailer will automatically receive an application that includes the traditional information from the system. To the extent that it is necessary, of course, the user must agree to the terms of the loyalty program before the system will release the information to the retailer. The user can also view all the programs that they are participating in through the system. The user will also be able to transfer to a retailer-specific webpage within their online account to view special offers and/or promotions. These promotions can then be accepted and then automatically linked to the user's online account.

(3) Offers, Coupons and Promotions

A user can also have the capability to view and search for coupons, offers or promotions (collectively referred to herein as “coupons”) from within their online account that are relative to a physical store or to the products they want to or might purchase when they are shopping in the physical store. When the user is in their online account and sees an offer they want to use, they can click on it to view the specifics of the offer, and then if they like it, they can accept it. The user also has the option of automatically accepting the offer using a one-click coupon acceptance feature. The purpose of the one-click feature is so a user can add a coupon, etc., to an online shopping cart and have it automatically redeemed in-store when a linked identifier is presented at checkout. If an offer is accepted, or if the one-click feature is used, the coupon is automatically placed in the user's online cart, presently called “My Coupons.” My Coupons is similar to an online shopping cart, but for using an online retailer's and/or manufacturer's coupons inside a brick-and-mortar store. It's not an online shopping cart in the sense that there's an online checkout with a paying visitor similar to a website purchase. Rather, the designation of the coupon into the account can be made online, but the purchase and/or use of the coupon is performed at the Point-of-Purchase location. Accordingly, the cart simply holds all the user's coupons in their account online for later use when the user actually walks into the store or buys a product that they had previously accepted a coupon for and placed in their online account. When the user is in-store and places the products for checkout, they can pay using a linked payment card or provide or punch-in a linked phone number as described herein. When a linked identifier is presented at checkout, the coupons that are in the user's online account will be automatically redeemed at the POS and the user's total and subsequent digital receipt can reflect those discounts. A user can accept and use coupons for any type of purchase or product. For example, a retailer might offer an in-store promotion specific to the retailer or store, but a manufacturer's products might be carried in multiple competing stores. If a user accepts manufacturer's coupons, which are not store specific, the user can be in any retailer and if they are buying a manufacturer's product that they have previously accepted a coupon for online, and coupon can be redeemed automatically regardless of the retailer who is carrying and selling the product.

In another embodiment, users can print a shopping list for the retailers and/or manufacturers coupons that they've accepted and linked to their online coupon cart. If desired, the printed shopping list can show a schematic plan view of the retailers store layout. The coupons in the user's online account that apply to the retailer and their printed shopping list can be referenced in the stores layout showing the user where their coupon-based products are located in the store aisles. In another embodiment, if a user prints a grocery store shopping list, a list of previously accepted manufacturers “grocery” coupon reminders can be printed to remind the user that they have a product coupon in their online cart. That is, the coupon itself need not be printed, just a line item stating the manufacturer and product for which they have a coupon. The list can have a description that says, for example, “Other manufacturer products you have online coupons for.”

From within the user interface, the user can see a screen that tells them they have several coupons which total a certain dollar amount. These coupons can be broken down by categories and can reflect the types of purchases the user might be interested in based on demographics and previous purchasing history. Each category can show the total potential savings. The user can also see how many coupons they currently have in “My Coupons” that are pending. My Coupons will also show them the total value of the pending coupons they have accepted, the dates of expiration, and the types of coupons they have in their cart and for whom and for what. For example, the types of coupons could be retailer and/or product specific. Lastly, the user can see how many coupons they've used to date and the respective savings amount.

(4) Points/Rewards System

In another embodiment, the system allows retailers and manufacturer's to tie points/rewards directly to specific products that the user is or may be likely to buy, use or try. Since the user has already “enrolled” in the service (as described above), the system will already have received the information that normally appears on a point or reward program application, or the system can simply request that the user provide their data on their account profile page before being able to participate in this type of a program. If the user's profile data has already been provided, our system provides a one-click enrollment feature. This feature can eliminate the need for the user to fill out an application for each program they choose to participate in. Plus, the company providing the program can automatically receive normal application information from us. To the extent necessary, the user must agree to terms before we will release said information to the retailer. Once the user is enrolled in a company's program, the system can keep track of purchases so that users automatically receive their points whenever they purchase a participating product from a store offering the product. Using the electronic receipt services described herein and the products' UPC codes, the system can verify that the customer purchased the product for the purposes of providing their points. The user can have the option of viewing details of all the programs that they are participating in from their online account. The user can then redeem these points from with their online account or they may click a web link to transfer to the company's web site.

(5) User and Receipt Enrollment

In another embodiment, the system allows retailers to create new user accounts from the POP by automatically linking their printed receipts for non-enrolled customers to the electronic receipt system. This can be accomplished, for example, by allowing the retailer to automatically generate and pull a unique code and a ghost user account number from our system every time a receipt is printed. The server's unique code can be linked to the details of the printed receipt that is stored in the retailers system, and the ghost user account number is linked to the unique code that represents a consumer who has not yet enrolled into the system. Once the unique code and account number have been created in our system, the unique code can be sent back to the retailer and printed on the paper receipt before it is given to the customer. The printed paper receipt can also print a disclaimer stating that the customer can go to a website, register to receive future receipts from the retailer in electronic format, key-in the unique code, and then receive the details of the paper receipt that had previously printed the unique code. If a customer decides to enroll into the electronic receipt program, they will be able to view their first electronic receipt upon login. This account creation and enrollment process eliminates any cashier-to-customer interaction as it relates to customer enrollment into an electronic receipt program at the POP. Because the enrollment process is automatic and requires the consumer to finalize enrollment at their convenience, it also reduces the amount of time other customers might spend in line waiting to checkout and pay. In contrast, if customers were required to provide an email address in order to enroll or to receive an electronic receipt, the time associated with this type of cashier-to-customer interaction can be time consuming and increase the amount of time a customer must wait in line, which is obviously a major concern for retailers.

Although preferred embodiments of this invention have been described above with a certain degree of particularity, those skilled in the art could make numerous alterations to the disclosed embodiments without departing from the spirit or scope of this invention. It is intended that all matter contained in the above description or shown in the accompanying drawings shall be interpreted as illustrative only and not limiting. Moreover, although the above-listed text and drawings contain titles and/or headings, it is to be understood that these titles and headings do not, and are not intended to, limit the present invention, but rather, they serve merely as titles and headings of convenience. Changes in detail or structure may be made without departing from the spirit of the invention as defined in the appended claims.

What is claimed is:

1. A system for facilitating in-person purchases and returns of products at a plurality of points-of-purchase, the system comprising:
a registration interface at a location remote from the points-of-purchase, the registration interface being configured to remotely receive identification information to register a user in the system and associate the registered user with a user account; and
a server at a location remote from the points-of-purchase and configured to communicate with a point-of-sale electronic payment systems resident at each point-of-purchase,
wherein the server is configured to receive and store a plurality of electronic receipts from the point-of-sale electronic payment systems, each electronic receipt being representative of one or more purchases made by a registered user at a point-of-purchase and including identification information provided by the registered user at the time of purchase,
wherein the server is configured to associate each electronic receipt with a single user account based on the identification information included with each electronic receipt, and
wherein, when a product return is initiated by a registered user at a point-of-purchase, the server is configured to receive the identification information of the registered user initiating the product return from the point-of-sale electronic payment system, identify the user account associated with the identification information, retrieve one or more electronic receipts associated with the user account, and transmit the retrieved electronic receipts to the point-of-sale electronic payment system to facilitate the product return.

2. The system of claim 1, wherein the electronic receipts comprise one or more unique retailer-specific transaction numbers that are used by a retailer at the point-of-purchase to locate or identify purchase information associated with the one or more purchases made by the registered user at the point-of-purchase.

3. The system of claim 1, further comprising an account interface at a location remote from the points-of-purchase, the account interface being configured to provide a registered user with access to their user account to retrieve and view the electronic receipts associated with the user account of the registered user.

4. The system of claim 3, wherein the account interface is configured to allow the registered user to identify and save electronic coupons in the user account of the registered user, the electronic coupons being automatically redeemable at a point-of-purchase upon the in-person purchase of a product covered by the coupon at the point-of-purchase, and the user being identified at the point-of-purchase using the identification information.

5. The system of claim 1, further comprising a second registration interface, the second registration interface being configured to remotely receive merchant information to register a merchant having one or more point-of-sale electronic payment systems in the system and associate the registered merchant with a merchant account.

6. The system of claim 1, wherein each electronic receipt includes a unique account number, a merchant account number, and a receipt number, and
wherein the unique account number is associated with a single user account, the merchant account number is associated with a single point-of-purchase, and the receipt number is associated with a purchase made by a registered user.

7. The system of claim 1, wherein the identification information comprises a number associated with a credit card or other payment card of the registered user.

8. The system of claim 1, wherein the identification information comprises a telephone number of the registered user.

9. An enrollment system for pre-registering merchants and users to facilitate purchases and returns of products at a plurality of points-of-purchase, the system comprising:
one or more enrollment interfaces located remotely from the points-of-purchase, the enrollment interfaces being configured to remotely receive registration information from a plurality of merchants and a plurality of users to register the merchants and users in the system, the enrollment interfaces associating one or more unique merchant account numbers with each registered merchant and one or more unique user account numbers with each registered user; and
a server located remotely from the points-of-purchase and accessible to the registered merchants and registered users through one or more communication networks,
wherein the server is configured to receive and store a plurality of electronic receipts, each electronic receipt being representative of an in-person sale of one or more products by a registered merchant to a registered user at a point-of-purchase operated by the registered merchant,
wherein each electronic receipt includes the unique user account number, the unique merchant account number, and a receipt number associated with the purchase made by the registered user at the point-of-purchase, and
wherein, when a product return is initiated by a registered user at a point-of-purchase of a registered merchant, the server is configured to receive the unique user account number of the registered user initiating the product return and provide the registered merchant with an electronic copy of at least one electronic receipt that includes both the unique user account number of the registered user and the unique merchant account number of the registered merchant.

10. The system of claim 9, wherein the remote server may be accessed by a registered user via the Internet, in order to retrieve and view the electronic receipts stored therein.

11. The system of claim 9, wherein the registered users may access the remote server and print a copy of one or more electronic receipts stored therein and associated with their unique user account number to facilitate the return of one or more products associated with the printed electronic receipts.

12. The system of claim 11, wherein the server restricts the number of copies that can be printed of any single electronic receipt retrieved from the remote server by the registered user.

13. The system of claim 9, wherein the registered user can receive electronic coupons and the remote server is configured to save electronic coupons and associate them with a registered user, the electronic coupons being automatically redeemable at the point-of-purchase of a registered merchant when the registered user provides the registered merchant with a unique user account number.

14. The system of claim 9, wherein the remote server can be accessed by a registered merchant in order to retrieve the electronic receipts associated with the registered merchant and to provide electronic coupons to one or more registered users.

15. A method for generating and storing electronic receipt information to facilitate in-person purchases and returns of products at a plurality of points-of-purchase, the method comprising:
registering a plurality of users with a plurality of respective user accounts;
associating a unique user identifier with each user account;
registering a plurality of merchants with a plurality of respective merchant accounts;
associating a unique merchant identifier with each merchant account;
receiving a plurality of electronic receipts from registered merchants at a remote server, each electronic receipt being representative of one or more in-person purchases made by a registered user at a point-of-purchase associated with a registered merchant;
storing the plurality of electronic receipts at the remote server;
receiving a request from a registered merchant for an electronic receipt stored at the remote server, the request including at least the unique user identifier and the unique merchant identifier;
identifying one or more electronic receipts stored at the remote server and associated with both the unique user identifier and the unique merchant identifier; and
transmitting the identified electronic receipt to the registered merchant so that the registered merchant can receive the electronic receipt and process a product return.

16. The method of claim 15, wherein the electronic receipt transmitted to the registered merchant comprises one or more unique transaction numbers that correspond to receipt identification information located or accessible at the point-of-purchase.

17. The method of claim 15, wherein the act of associating each user account with a unique user identifier comprises:
accepting credit or debit card information entered by the registered user, truncating said credit or debit card information, and storing said truncated credit or debit card information in a database.

18. The method of claim 15, further comprising:
receiving product return information from the registered merchant indicating whether a product has been returned to the registered merchant;
updating the electronic receipt stored at the remote server to reflect the product return; and
storing the updated electronic receipt at the remote server.

19. The method of claim 18, wherein the remote server may be accessed by the registered user via the Internet, in order to retrieve the updated electronic receipt stored therein.

20. The method of claim 19, wherein a registered user may access the remote server and the updated electronic receipt stored therein in order to generate a paper receipt which may be downloaded to and printed on a local printer.

21. A computer-readable storage medium storing computer-executable instructions for causing a computer to perform a method, the method comprising:
registering a plurality of users with a plurality of respective user accounts;
associating a unique user identifier with each user account;
registering a plurality of merchants with a plurality of respective merchant accounts;
associating a unique merchant identifier with each merchant account;
receiving a plurality of electronic receipts from registered merchants, each electronic receipt being representative of one or more in-person purchases made by a registered user at a point-of-purchase associated with a registered merchant;
storing the plurality of electronic receipts;
receiving a request from a registered merchant for an electronic receipt, the request including at least the unique user identifier and the unique merchant identifier;
identifying one or more electronic receipts associated with both the unique user identifier and the unique merchant identifier; and
transmitting the identified electronic receipt to the registered merchant.
